(19) United States
(12) Patent Application Publication
(10) Pub. No.: US 2004/0027609 A1
(43) Pub. Date: Feb. 12, 2004

(54) Image processing apparatus and image processing method

(75) Inventors: Youichi Isaka, Kanagawa (JP); Yukio Kumazawa, Kanagawa (JP); Masanori Onda, Kanagawa (JP); Yumi Sekiguchi, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/388,809

(22) Filed: Mar. 17, 2003

(30) Foreign Application Priority Data
Mar. 19, 2002 (JP) 2002-076925

(51) Int. Cl. B41F 1/00; G06F 15/00; G06K 9/60

(52) U.S. Cl. 358/1.15; 382/303; 382/304

(57) ABSTRACT

In a pipeline process structure having a plurality of processing functions 131-1 to 131-N which are connected to each other in a pipeline mode so as to execute predetermined process operations, while an image information read-skipping unit 132 for skipping a reading operation of a portion of image information to be processed is provided with at least one of these plural processing functions 131-1 to 131-N, when the image information is processed on such a system for requiring/releasing a memory, the image information can be effectively processed and acquired.

### BACKGROUND OF THE INVENTION

The present invention generally relates to an image processing apparatus and an image processing method, which process digitally-processed image data. More specifically, the present invention is directed to an image processing apparatus and an image processing method, in which a plurality of element/functional image process modules are prepared, and various sorts of image processing functions can be realized by combining these image process modules with each other.

Techniques capable of providing various sorts of image processing functions by preparing a plurality of element/functional image processing modules and by combing these element/functional image processing modules with each other are utilized in various systems capable of handling digital images, for example, document editors, drawing tools, image transfer apparatus, printers, and the like. Then, such image processing functions may be provided as image processing libraries in some cases. In the case of these image processing libraries, functions thereof may be utilized by linking the image processing libraries to application programs by which the image processing functions are wanted to be utilized.

In DTP (desk top publishing) systems capable of inputting images, and print systems capable of outputting images, various sorts of image processing operations are carried out with respect to images which should be processed. In these image processing operations, for instance, scaling operations, rotating operations, affine transformations, color conversions, filtering processes, combining operations, and the like are carried out. When these image processing operations are carried out, these image processing operations may be carried out by employing dedicated hardware in such a case that attributes, image processed contents, sequential orders, parameters of input images are fixed. However, for instance, in such a case that various types (different color spaces, and different bit numbers per bit) are entered, and/or sequential orders of image processed contents and parameters thereof are changed, these image processing operations must be carried out by properly employing image-processing arrangements having more flexible characteristics.

As unit capable of satisfying such a requirement, several conventional techniques are proposed, by which desirable image processing operations can be carried out in flexible manners while programmable modules are connected to each other in pipeline modes and/or DAG (Directed Acyclic Graph) modes (for example, the Unexamined Japanese Patent Application Publication Nos. Hei5-260373 and Hei7-105020).

The Unexamined Japanese Patent Application Publication No. Hei5-260373 describes the digital picture signal processing apparatus capable of executing the high calculating process operation in high speeds by arranging this digital picture signal processing apparatus in such a manner that both the respective calculating process contents of a plurality of programmable calculating process units, and the connection modes of the respective programmable calculating process units by way of the network unit can be freely set via the host control unit from the external unit. Thus, the digital picture signal processing apparatus may have high flexibility with respect to changes in the functions and changes in the systems.

Further, the Unexamined Japanese Patent Application Publication No. Hei7-10502 describes the pipeline-formed image processing system capable of executing the image processing operation in the flexible manner, since the necessary functional modules are connected in the pipeline shape and initialized in the desirable sequence so as to execute the image processing operation. The operations of this pipeline-formed image processing system are carried out as follows:

In other words, when the connection of the necessary functional modules is completed, the acquisition of the header is requested with respect to the last-positioned functional module, if required. This request is sequentially traced through the connected modules, and then is reached to the image input module located at the top, and the header information of the image to be read is returned. After each of the modules rewrites the information of the portion changed by the own module, this module transfers the rewritten information to the post-staged module. For instance, in such a case that a size of an input image is defined by (1000×1000) pixels, and a compressing process module capable of compressing the above-described image size into (500×500) pixels is contained in the processing pipeline, this compressing process module changes the size information (1000×1000 pixels) contained in the header information which is transferred from the pre-staged module into another size information (500×500 pixels), and then, transfers this changed size information to the post-staged module.

While such an image processing operation is sequentially repeated, the last-positioned process module finally outputs to the external unit, the header information of the image which is outputted by this image processing pipeline. Next, the data processing operation is carried out based upon the acquired header information and the like. Similar to the header information processing operation, this data processing operation is performed in such a manner that when a constant amount of data is requested to be outputted with respect to the last-positioned module, this last-positioned module requires the pre-staged module to input such an image data required for this data processing operation. This request is traced back to the pre-staged module so as to be transferred to the image input module in a similar manner, the necessary image data is read out from the image input module, and then, this read necessary image data is transferred to the post-staged process module. Then, while this image data is sequentially processed, the processed image data is finally outputted from the last-positioned process module.

When the above-explained image processing operation is carried out as to the final image, or the necessary image portion, since the processing pipeline is no longer required, the completion of the image processing operation is requested with respect to the last-positioned process module. Similar to the header information acquiring operation and the above-described process operation, this completion request is similarly traced back to the connections of these process modules, and thereafter, is reached to the front most image input module. Then, this image input module releases the resources employed in the process operation, and releases the own module, and then returns the control to the post-staged module. This post-staged module to which the control is returned similarly performs such a process operation for releasing the resources and the own module, and further, returns this control to the post-staged module. At such a time instant when releasing of the resources/own module as to the last-positioned module is accomplished, all of the image processing operations are accomplished.

The above-described conventional technique described in the Unexamined Japanese Patent Application Publication No. Hei7-105020 implies that the simulation system for the multiple processing pipeline constructed by the single processor, which is utilized in such an operating system (OS) as UNIX (registered trademark), is applied to technical fields such as an image processing field. Then, more specifically, in this image processing field, since a single processing unit is limited to a portion of an image, for example, one line of an image is limited to be processed, each of the process modules can extremely reduce memory areas used to hold image-processed data.

As a result, this conventional technique can provide the low-cost image processing apparatus capable of executing the complex image processing operations with using the small memory capacity. Alternatively, in the case that such an image processing apparatus is operable on an operating system for supporting a virtual memory, since “swap out” caused by a shortage of memory capacity can be suppressed to a minimum, this image processing apparatus can execute the image processing operation in a high speed.

Furthermore, as another conventional technique, the following image processing apparatus is proposed (see the Unexamined Japanese Patent Application Publication No.Hei8-272981). That is, for instance, in such a process operation that an entire input image is required in order to obtain 1 line of an output image, e.g., in a 90-degree rotating process operation, or in such a case of branching modules in which an input image is outputted to a plurality of process modules, when buffering of the entire image is ended, an ending process operation is carried out with respect to a pre-staged module. As a consequence, while a necessary memory resource can be suppressed to a minimum resource mount, the image can be processed in high speeds.

However, in the conventional technique described in the Unexamined Japanese Patent Application Publication No. Hei8-272981, the output of the clip process module for executing the process operation in order to acquire only, for example, the image information of the specific range (clip range) of the image to be processed is performed as to the input image information within the clip range. However, the reading process operation to the process module as to the input image information outside the clip range is carried out, which gives no adverse influence to the output information. As a result, the computer resource is consumed in the useless manner.

Further, for example, in the case of such an inverting process module capable of inverting up/down portions of an image, since a first line of a module output corresponds to a final module input line and also a second line of the module output corresponds to a second final module input line, a page buffer must be held in the module in the above-described conventional technique, so that a large number of memory resources are consumed.

### SUMMARY OF THE INVENTION

The present invention is made to solve the above-explained problem, and therefore, has an object to provide both an image processing apparatus and an image processing method, in which when image information is processed on such a system for requiring/releasing a memory, the image information can be effectively processed and acquired.

To achieve the above-explained object, in a pipeline process structure constituted by connecting a plurality of processing unit (processing modules) for executing predetermined process operations in a pipeline mode, at least one of these plural processing modules is comprised of an image information read-skipping function (so-called skipping process) for skipping a reading operation of a portion of image information to be processed, while the processing module executes a predetermined process operation.

Since at least one of these plural processing unit (processing modules) is provided with the image information read-skipping function in the pipeline process structure, the useless reading process operation of the image information to this processing unit (processing module) can be suppressed. As a result, the image processing operation can be carried out in higher speeds. Moreover, since the reading operation of the image information is skipped to the necessary image information position, the unnecessary image information reading operation can be avoided, and also the useless buffering operation can be avoided, so that the memory consumption amount can be suppressed.

### BRIEF DESCRIPTION OF THE DRAWINGS

FIG. 1 is a block diagram for indicating a structural example of an image processing apparatus according to the present invention.

FIG. 2 is a block diagram for showing a structural example of an image processing unit according to a first embodiment mode.

FIG. 3 is a block diagram for representing a modification of the image processing unit according to the first embodiment mode.

FIG. 4 is a block diagram for showing a structural example of a process execution control unit.

FIG. 5 is a block diagram for indicating a structural example of an image process pipeline.

FIG. 6 is an explanatory diagram for explaining operations executed in the case that read-skipping operation of image information along a forward direction of a sub-scanning direction is carried out.

FIG. 7 is an explanatory diagram for explaining operations executed in the case that read-skipping operation of image information along a backward direction of the sub-scanning direction is carried out.

FIG. 8 is an explanatory diagram for explaining operations executed in the case that read-skipping operation of image information along a forward direction of a main scanning direction is carried out.

FIG. 9 is an explanatory diagram for explaining operations executed in the case that read-skipping operation of image information along a backward direction of the main scanning direction is carried out.

FIG. 10 is a block diagram for showing a structural example of an image processing unit according to a second embodiment mode.

FIG. 11 is a block diagram for representing a modification of the image processing unit according to the second embodiment mode.

FIG. 12 is a block diagram for representing another modification of the image processing unit according to the second embodiment mode.

FIG. 13 is an explanatory diagram for explaining operations executed in the case that an image information read-skipping control function is realized.

FIG. 14 is a block diagram for indicating another structural example of a process module.

FIG. 15 is a block diagram for showing a structural example of a pipeline of a clip process operation according to a first concrete example.

FIG. 16 is a diagram for representing an image and a clip region thereof.

FIG. 17 is a flow chart for indicating a process flow operation of a clip process module.

FIG. 18 is a flow chart for describing a process flow operation in the case that the clip process module processes an image.

FIG. 19 is a block diagram for showing a structural example of a pipeline of an up/down inverting process operation according to a second concrete example.

FIG. 20 is a flow chart for indicating a process flow operation of an up/down inverting process module.

FIG. 21 is a diagram for showing both an image obtained before the up/down inverting process operation, and another image obtained after the up/down inverting process operation.

### DETAILED DESCRIPTION OF THE PREFERRED EMBODIMENTS

Referring now to drawings, embodiment modes of the present invention will be explained in detail with reference to drawings.

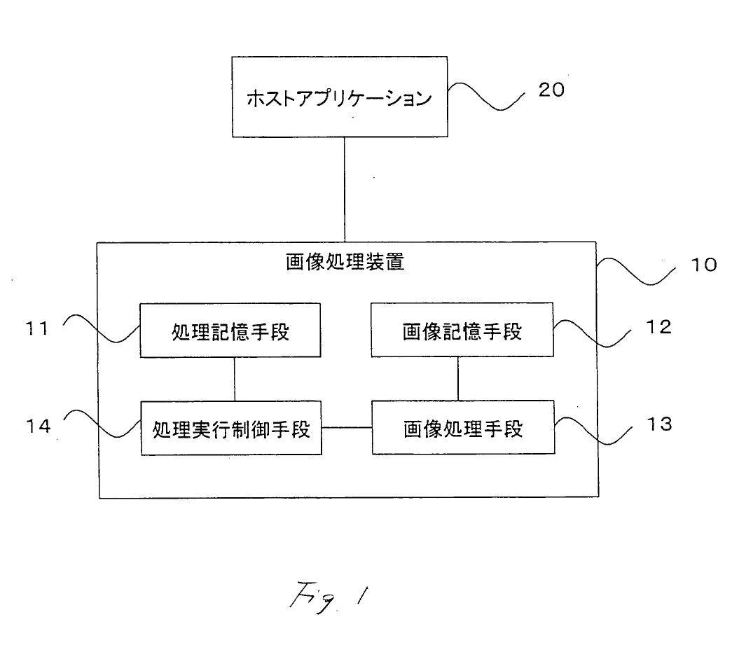

FIG. 1 is a block diagram for schematically showing a structural example of an image processing apparatus 10 according to the present invention. As apparent from FIG. 1, this image processing apparatus 10 is constituted by such a system provided with a process storage unit 11, an image storage unit 12, an image processing unit 13, and a process execution control unit 14. The process storage unit 11 stores there into an image processing command (image processing instruction) supplied from a host application (program) 20. The image storage unit 12 stores there into image information. The image processing unit 13 executes an image processing operation as to an image stored in the image storage unit 12 in accordance with the image processing instruction stored in the process storage unit 11. The process execution control unit 14 controls the execution of the image processing operation.

### FIRST EMBODIMENT

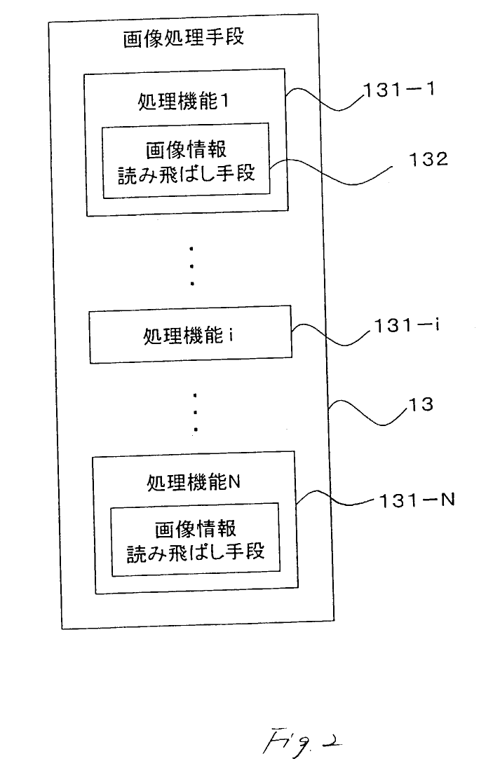

FIG. 2 is a block diagram for schematically indicating a structural example of the image processing unit 13 according to a first embodiment mode of the present invention.

As apparent from FIG. 2, the image processing unit 13 according to this embodiment mode is arranged by containing at least one processing function capable of executing various sorts of process operations, for instance, “N” pieces of processing functions 131-1 to 131-N. Further, at least one of these processing functions 131-1 to 131-N owns an image information read-skipping unit 132, and a process module which is produced from the processing function having this image information read-skipping unit 132 owns an image information read-skipping function. This image information read-skipping function will be discussed later in detail.

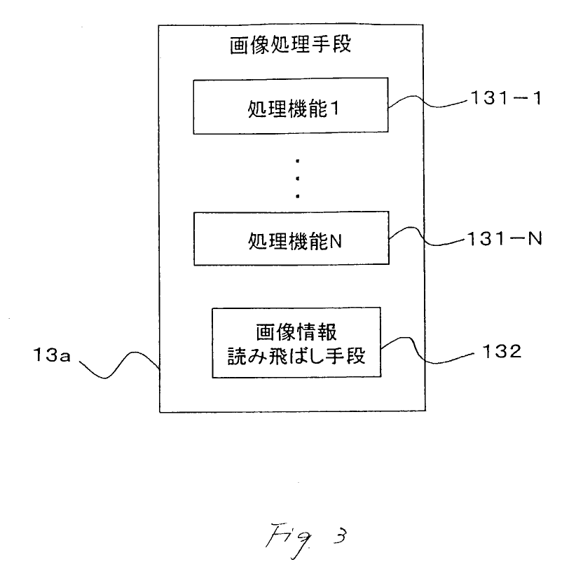

As a modification example of the image processing unit 13, as indicated in FIG. 3, such an image processing unit 13a may be constructed. That is, while the image information read-skipping unit 132 is held by a processing function other than the above-described processing functions 131-1 to 131-N, when a process module is produced, the image information read-skipping function may be provided in the process module.

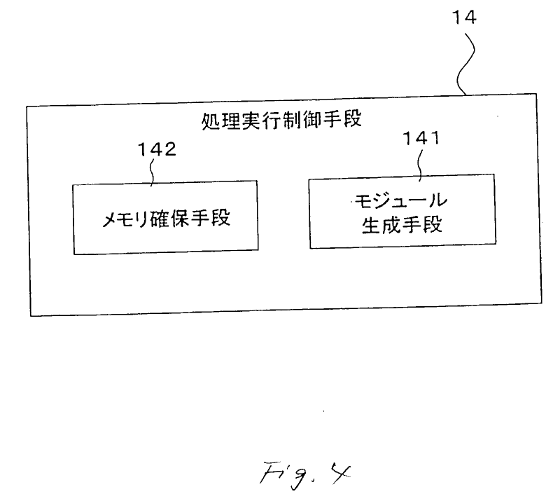

Further, as shown in FIG. 4, the process execution control unit 14 is arranged by having a module producing unit 141 and a memory securing unit 142. The module producing unit 141 executes a production of a process module and also a connection between process modules from the processing functions 131-1 to 131-N corresponding to an image processing command stored in the process storage unit 11. The memory securing unit 142 secures and releases both a memory for expanding the respective process modules, and a buffer which is utilized by the respective process modules. It should also be noted that a process module may own a unit for securing and releasing a memory functioning as a buffer. However, this modification is omitted in the below-mentioned explanations.

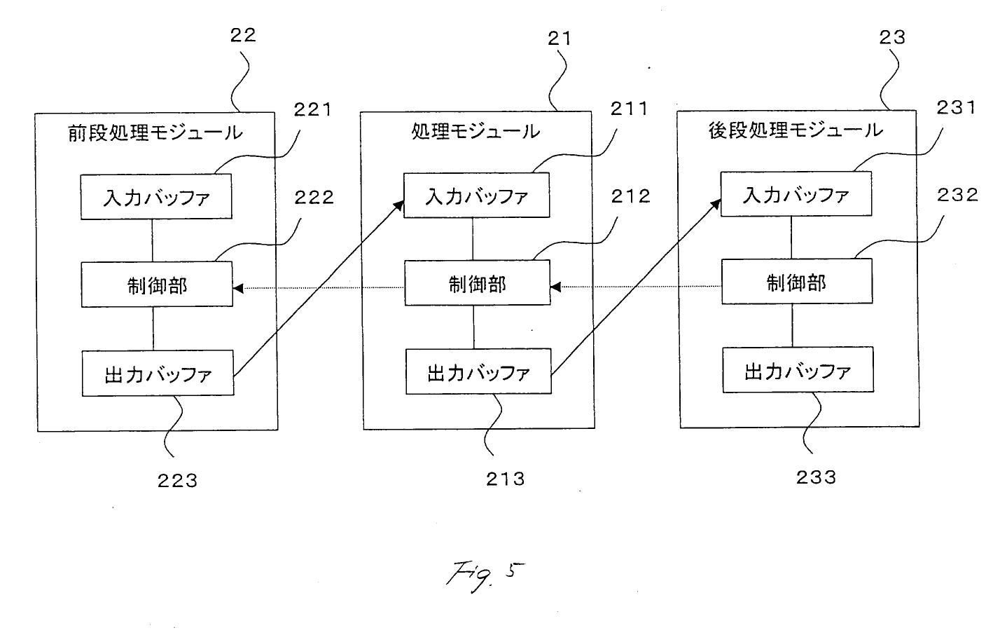

FIG. 5 is a block diagram for illustratively explaining a structure of a pipeline constructed by connecting a pre-staged process module 22 with a post-staged process module 23 with respect to a process module 21 produced by a module processing unit 141.

The process module 21 is constituted by containing an input buffer 211, a control unit 212, and an output buffer 213. The input buffer 211 is used to hold therein image information acquired from the pre-staged process module 22. The control unit 212 controls the process module 21. The output module 213 is used to output such image information which is processed in the process module 21 to the post-staged process module 23. Similarly, the pre-staged process module 22 owns an input buffer 221, a control unit 222, and an output buffer 223. The post-staged process module 23 owns an input buffer 231, a control unit 232, and an output buffer 233.

In this pipeline process structure, when the pre-staged process module 21 receives an image information output request issued from the post-staged process module 23, this output request is transferred to the control unit 212. As a result, the control unit 212 sends the image information output request with respect to the pre-staged process module 22. Since this pre-staged process module 22 which has received the image information output request writes the processed image information into the output buffer 223, the control unit 212 of the process module 21 copies the image information to the input buffer 211. Then, the control unit 212 writes a processed result of the image information of the input buffer 211 into the output buffer 213, and then, this processed image information is copied to the input buffer 231 by the control unit 232 of the post-staged process module 23.

When the process module 21 receives an image information read-skipping request from the post-staged process module 23, this read-skipping request is transferred to the control unit 212. The control unit 212 changes an image information process starting position defined when a next image information output request is issued, and when an image information amount which is read-skipped becomes short of image information by merely read-skipping the image information held in the input buffer 211, the control unit 212 sends an image information read-skipping request to the pre-staged process module 22. At this stage, the pre-staged process module 22 which receives this image information read-skipping request is operated in a similar manner to that of the process module 21 when the image information read-skipping request is received.

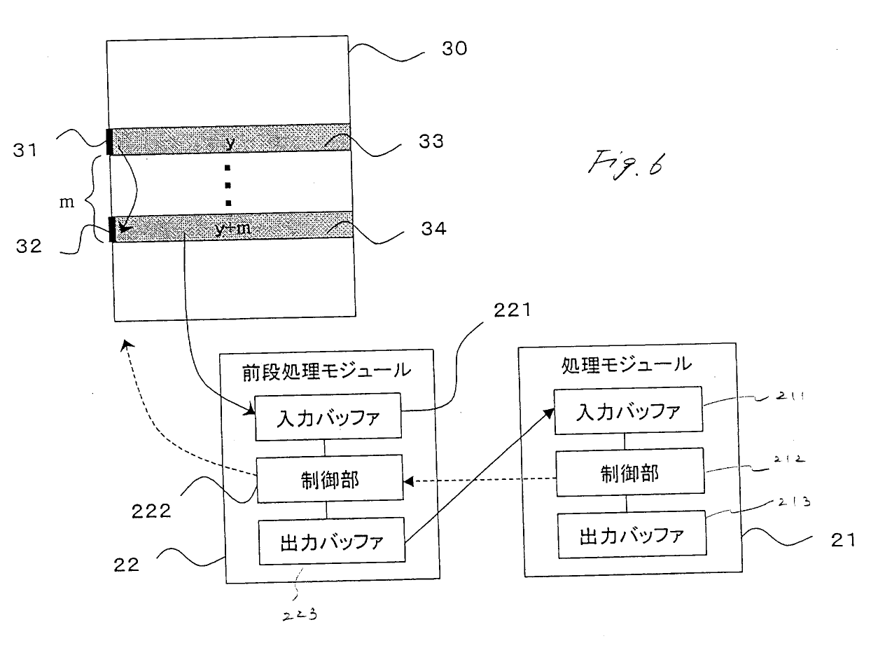

FIG. 6 is an explanatory diagram for explaining operations executed in the case that an image information read-skipping request corresponds to such a request for instructing that “m” lines of image information read-skipping operations are carried out along a forward direction with respect to a sub-scanning direction.

It is so assumed that an image information process starting position of the pre-staged process module 22 is set to a position 31 equal to a head pixel of a “y-th” line with respect to image information 30. When the pre-staged process module 22 receives the image information read-skipping request from the process module 21, which instructs “m” lines of image information read-skipping operations along the forward direction from the process module 21, if a process module is further connected to another process module at a pre-stage of this pre-staged process module 22, then the pre-staged process module 22 instructs this process module to execute the “m” lines of image information read-skipping operations along the forward direction. This process operation is equivalent to such a process operation that the image information process starting position of the pre-staged process module 22 is again set from the head pixel position 31 of the “y-th” line to another head pixel position 32 of a (y+m)-th line.

Next, when the pre-staged process module 22 receives an image information output request from the process module 21, the control unit 222 of the pre-staged process module 22 further sends the image information output request to the process module at the pre-stage, and copies the returned image information to the input buffer 221. When the image information output request is received, since the image information process starting position is set to the position 32, this image information copied to the input buffer 221 is not equal to image information 33 in the “y-th” line, but is equal to such an image information 34 in the (y+m)-th line. Then, the pre-staged process module 22 returns a processed result of the image information 34 held in the input buffer 221 to the process module 21.

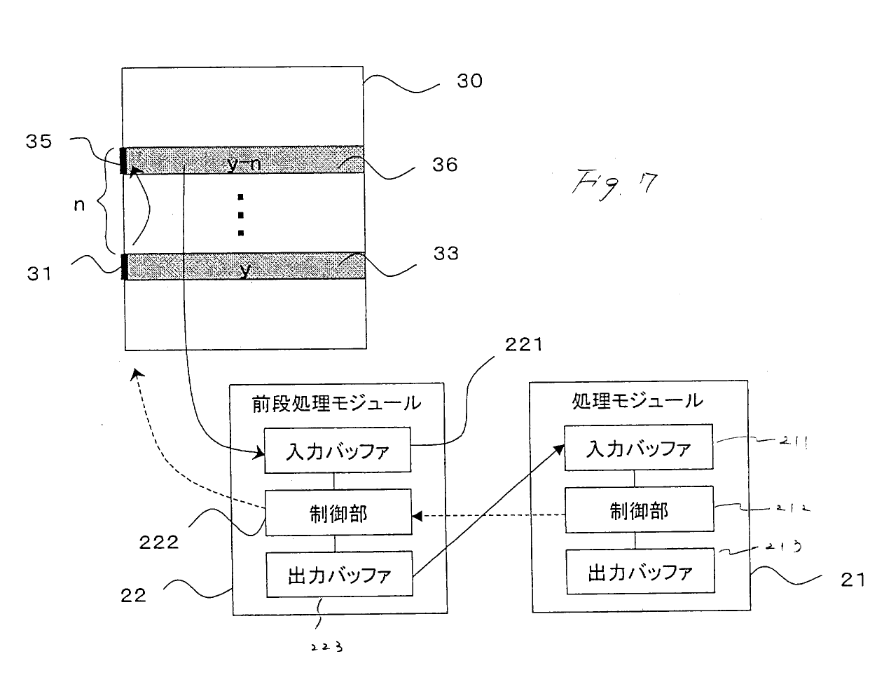

FIG. 7 is an explanatory diagram for explaining operations executed in the case that an image information read-skipping request corresponds to such a request for instructing that “n” lines of image information read-skipping operations are carried out along a backward direction with respect to the sub-scanning direction.

It is so assumed that an image information process starting position of the pre-staged process module 22 is set to a position 31 equal to a head pixel of a “y-th” line with respect to image information 30. When the pre-staged process module 22 receives the image information read-skipping request from the process module 21, which instructs “n” lines of image information read-skipping operations along the backward direction from the process module 21, if a process module is further connected to another process module at a pre-stage of this pre-staged process module 22, then the pre-staged process module 22 instructs this process module to execute the “n” lines of image information read-skipping operations along the backward direction. This process operation is equivalent to such a process operation that the image information process starting position of the pre-staged process module 22 is again set from the head pixel position 31 of the “y-th” line to another head pixel position 35 of a (y−n)-th line.

Next, when the pre-staged process module 22 receives an image information output request from the process module 21, the control unit 222 of the pre-staged process module 22 further sends the image information output request to the process module at the pre-stage, and copies the returned image information to the input buffer 221. When the image information output request is received, since the image information process starting position is set to the position 35, this image information copied to the input buffer 221 is not equal to image information 33 in the “y”-th line, but is equal to such an image information 36 in the (y−n)-th line. Then, the pre-staged process module 22 returns a processed result of the image information 36 held in the input buffer 221 to the process module 21.

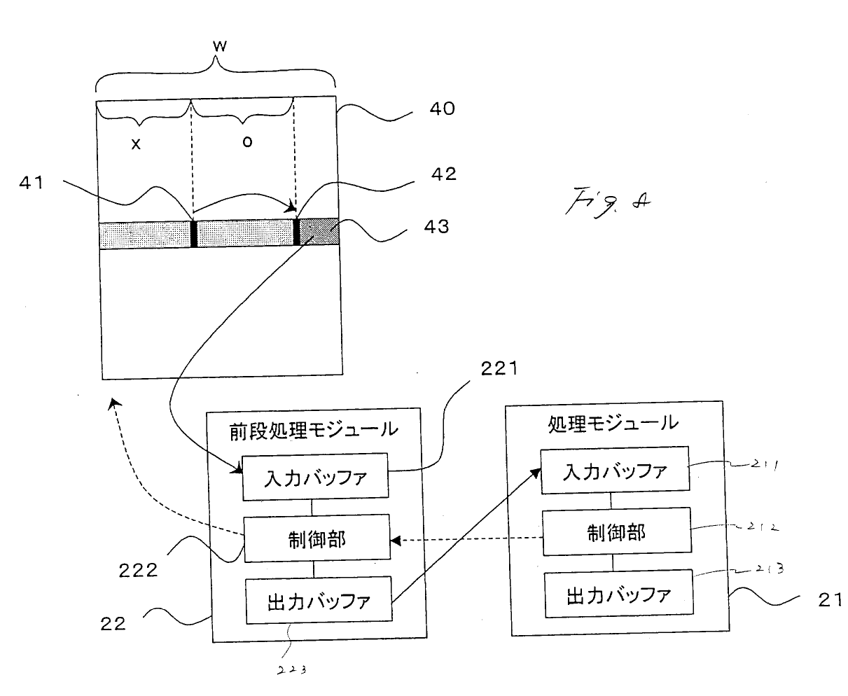

FIG. 8 is an explanatory diagram for explaining operations executed in the case that an image information read-skipping request corresponds to such a request for instructing that “o” pixels of image information read-skipping operations are carried out along a forward direction with respect to a main scanning direction.

It is so assumed that an image information process starting position of the pre-staged process module 22 is set to a position 41 of an “x-th” pixel along the main scanning direction with respect to image information 40 having a width of “w” pixels. When the pre-staged process module 22 receives the image information read-skipping request from the process module 21, which instructs “o” pixels of image information read-skipping operations along the forward direction from the process module 21, if a process module is further connected to another process module at a pre-stage of this pre-staged process module 22, then the pre-staged process module 22 further instructs this process module to execute the “o” pixels of image information read-skipping operations along the forward direction. This process operation is equivalent to such a process operation that the image information process starting position of the pre-staged process module 22 is again set from the position 41 of the “x-th” pixel along the main scanning direction to a position 42 of an (x+o)-th pixel along the main scanning direction.

Next, when the pre-staged process module 22 receives an image information output request from the process module 21, the control unit 222 of the pre-staged process module 22 further sends the image information output request to the process module at the pre-stage, and copies the returned image information to the input buffer 221. When the image information output request is received, since the image information process starting position is set to the position 42, this image information copied in the input buffer 221 is equal to such an image information 43 constructed of (w−x−o) pixels. Then, the pre-staged process module 22 returns a processed result of the image information 43 held in the input buffer 221 to the process module 21.

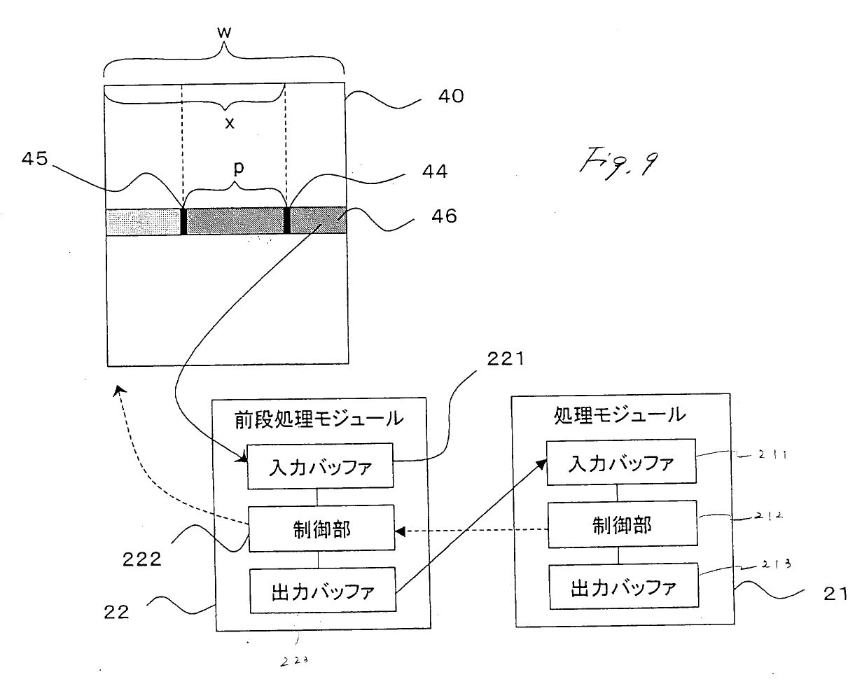

FIG. 9 is an explanatory diagram for explaining operations executed in the case that an image information read-skipping request corresponds to such a request for instructing that “p” pixels of image information read-skipping operations are carried out along a backward direction with respect to the main scanning direction.

It is so assumed that an image information process starting position of the pre-staged process module 22 is set to a position 44 of an “x-th” pixel along the main scanning direction with respect to image information 40 having a width of “w” pixels. When the pre-staged process module 22 receives the image information read-skipping request from the process module 21, which instructs “p” pixels of image information read-skipping operations along the backward direction from the process module 21, if a process module is further connected to another process module at a pre-stage of this pre-staged process module 22, then the pre-staged process module 22 further instructs this process module to execute the “p” pixels of image information read-skipping operations along the backward direction. This process operation is equivalent to such a process operation that the image information process starting position of the pre-staged process module 22 is again set from the position 44 of the “x-th” pixel along the main scanning direction to a position 45 of an (x−p)-th pixel along the main scanning direction.

Next, when the pre-staged process module 22 receives an image information output request from the process module 21, the control unit 222 of the pre-staged process module 22 further sends the image information output request to the process module at the pre-stage, and copies the returned image information to the input buffer 221. When the image information output request is received, since the image information process starting position is set to the position 41, this image information copied in the input buffer 221 is equal to such an image information 46 constructed of (w−x+p) pixels. Then, the pre-staged process module 22 returns a processed result of the image information 46 held in the input buffer 221 to the process module 21.

As previously described, in accordance with the image processing unit 13 of the first embodiment mode, in the pipeline process structure constituted by connecting a plurality of process modules 22, 21, 23 in the pipeline mode, for example, since the process module 21 is provided with the image information read-skipping (skipping process) function, the useless reading process operation of the image information to this process module 21 can be suppressed. As a result, the image processing operation can be carried out in a high speed. Moreover, since the image information is read-skipped up to the necessary image information position, the unnecessary image information reading operation can be avoided and also the useless buffering operation can be avoided. Accordingly, the memory consumption amount can be suppressed. As a consequence, while the image information is processed on the system in which the memories are requested/released, the image information can be effectively processed and acquired.

### SECOND EMBODIMENT

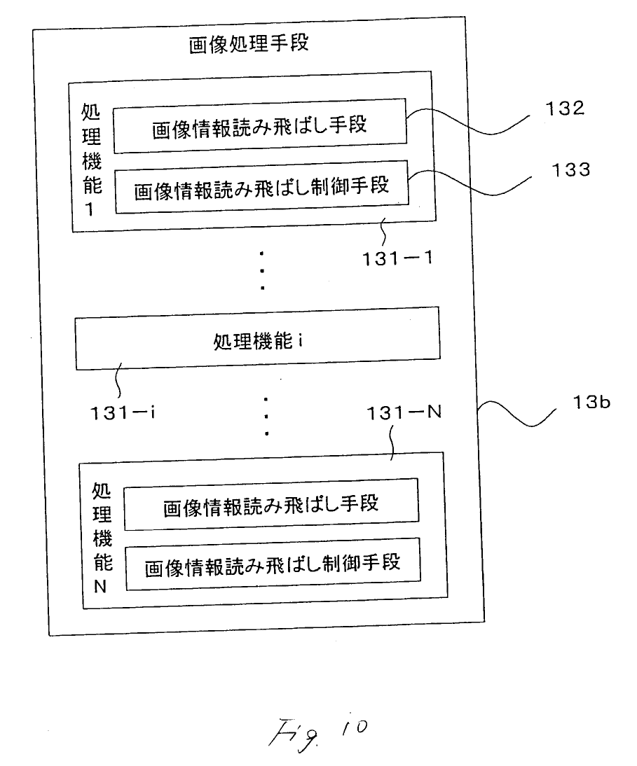

FIG. 10 is a block diagram for schematically indicating a structural example of the image processing unit 13b according to a second embodiment mode of the present invention. It should be noted that the same reference numerals shown in FIG. 2 will be employed as those for indicating the same, or similar structural elements indicated in FIG. 10.

As apparent from FIG. 10, the image processing unit 13b according to this second embodiment mode is arranged by containing at least one processing function capable of executing various sorts of process operations, for instance, “N” pieces of processing functions 131-1 to 131-N. Further, any of these processing functions 131-1 to 131-N owns an image information read-skipping unit 132, and an image information read-skipping control unit 133. A process module which is produced from the processing function having both the image information read-skipping unit 132 and the image information read-skipping control unit 133 is arranged by having both an image information read-skipping function and an image information read-skipping control function.

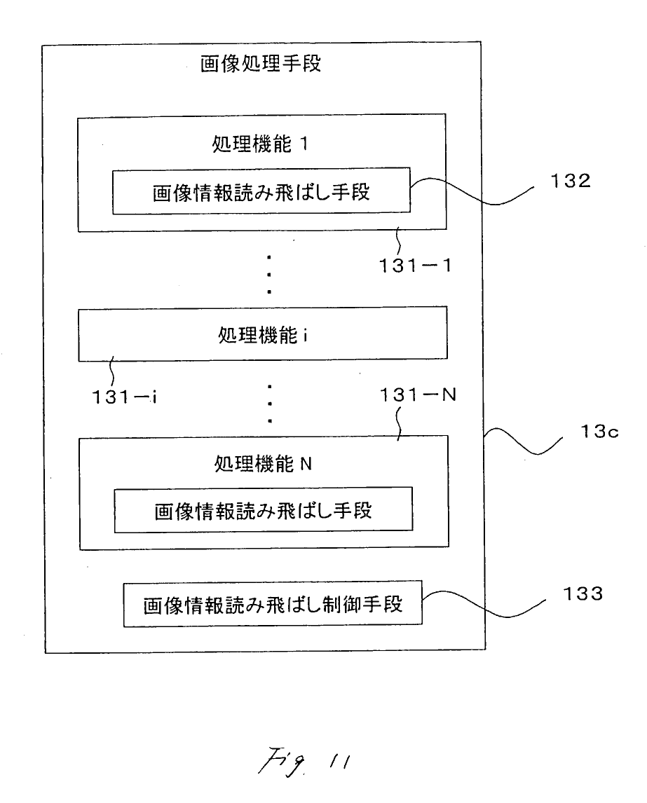

As a modification example of the image processing unit 13b, as indicated in FIG. 11, such an image processing unit 13c may be constructed. That is, while the image information read-skipping unit 132 is provided with the above-described processing functions 131-1 to 131-N, the image information read-skipping control unit 133 is provided in a separate manner with respect to the processing functions 131-1 to 131-N. Process modules which are produced from the processing functions 131-1 to 131-N equipped with the image information read-skipping unit 132 own both image information read-skipping functions and image information read-skipping control functions.

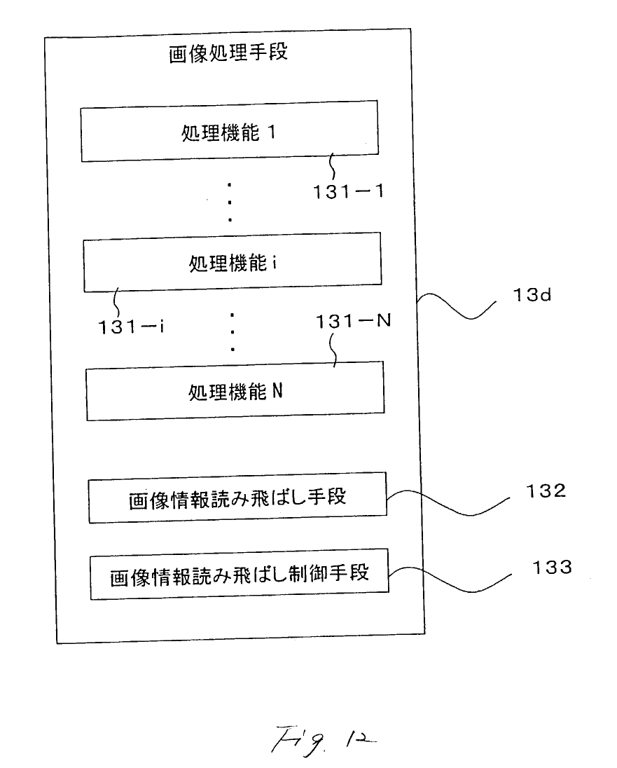

Further, as represented in FIG. 12, as another modification of the image processing unit 13b, such an image processing unit 13d may be constructed. That is, both the image information read-skipping unit 132 and the image information read-skipping control unit 133 are provided in a separate manner with respect to the processing functions 131-1 to 131-N. In this alternative case, when the module producing unit 141 (see FIG. 4) produces the module, both the image information read-skipping function and the image information read-skipping control function are provided with such a process module which is produced for the process function requiring the image information read-skipping function.

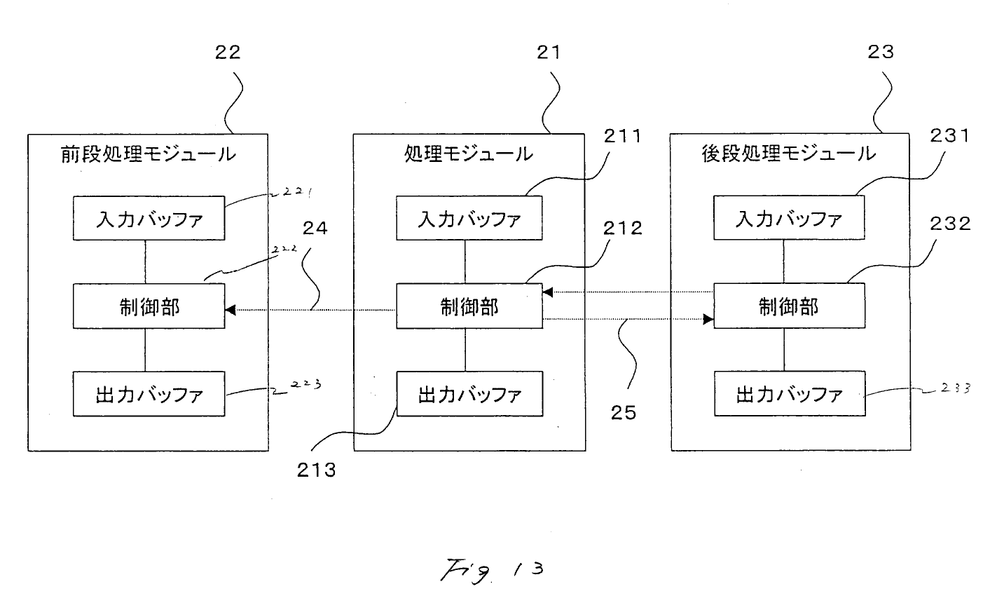

FIG. 13 is an explanatory diagram for explaining operations executed in the case that the process module 21 is equipped with the image information read-skipping control function. It should also be understood that the same reference numerals shown in FIG. 5 will be employed as those for denoting the same, or similar structural elements in this drawing.

When the process module 21 receives an image information read-skipping request from the post-staged process module 23, the image information read-skipping control function of the control unit 212 thereof judges as to whether or not the pre-staged process module 22 can perform the image information read-skipping operation. In the case that the pre-staged process module 22 can execute the image information read-skipping operation, the control unit 212 sends an image information read-skipping request 24 to the pre-staged process module 22. To the contrary, in the case that the pre-staged process module 22 cannot execute this image information read-skipping operation, the control unit 212 executes no process operation. Otherwise, the control unit 212 transmits an error notification 25 for notifying that the image information read-skipping operation fails to module 23.

As previously explained, in accordance with the second embodiment mode, since the image information read-skipping control function is also provided with the process module in addition to the image information read-skipping function of the first embodiment mode, in the case that, for instance, input image information to the process module corresponds to such a compressed information that image information is dropped by skipping the reading operation of the input image information, such a control operation can be carried out. That is, the image information processing operation can be carried out without read-skipping of the image information. As a consequence, the connection to the process modules can be carried out without paying any attention to such a condition for indicating as to whether the input image information to the process module is compressed, or not compressed.

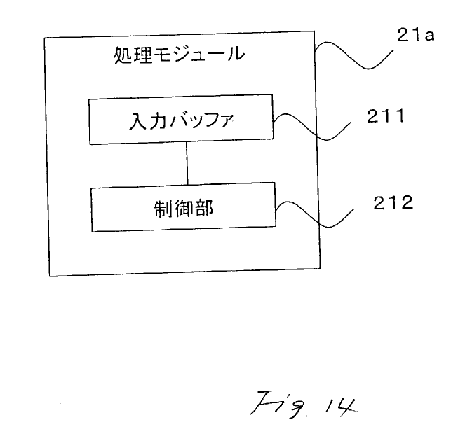

For the sake of easy explanations in the above-described descriptions, the process module 21 owns both the input buffer 211 and the output buffer 213. Alternatively, as shown in FIG. 14, such a process module 21a having only the input buffer 211 may be employed. When the process module 21a accepts an image information output request from the post-staged process module 23, the control unit 212 directly writes the processed result into the input buffer 231 of the post-staged process module 23. In such an arrangement, since copying operation of the image information is not required from the output buffer 213 to the input buffer 231 of the post-staged process module 23, an improvement in the processing speed may be expected. Further, since the output buffer 213 is not required, the memory resources may be saved by this output buffer 213.

### FIRST EXAMPLE

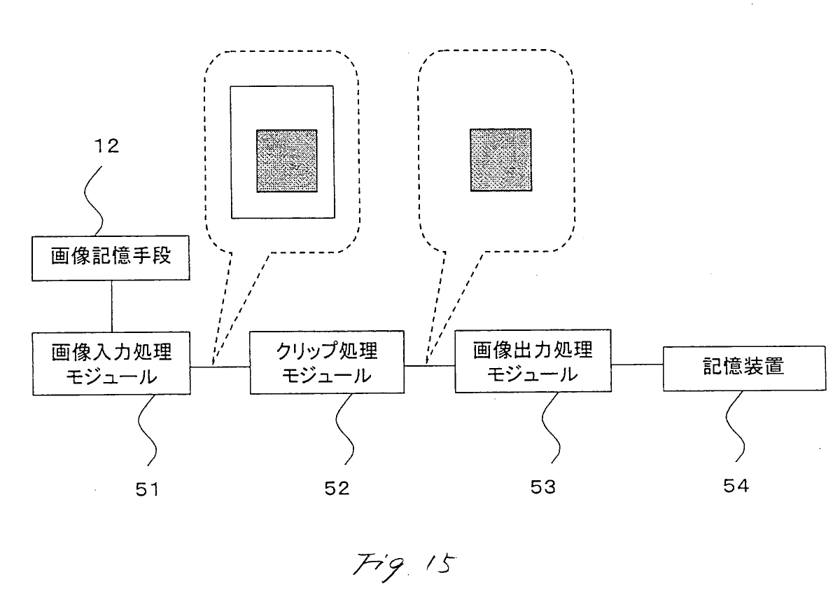

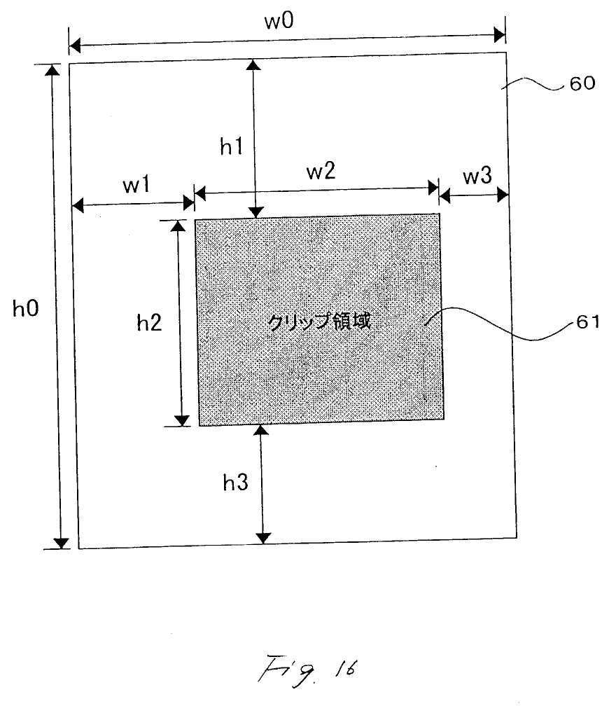

As indicated in FIG. 15, this first concrete example corresponds to such an example as to operations of a clip process module 52 when an image 60 shown in FIG. 16 is processed which is stored in the image storage unit 12 of FIG. 1 in the case that a pipeline structure made by connecting an image input process module 51, the clip process module 52, and an image output process module 53 to each other is constituted.

First, a general operation of the clip process module 52 is explained, and then, operations of this clip process module 52 when the image 60 is processed will be described based upon this general operation. First of all, the memory securing unit 142 of FIG. 4 secures a memory which is required in order to produce a process module based upon an image process instruction stored in the process storage unit 11 of FIG. 1. In this first concrete example, the image process instruction implies such an process operation that the image information 60 is read out from the image storage unit 12 by way of the image input function, a region 61 is clipped from the image storage unit 12 by way of a clip processing function, and thereafter, image information obtained after the above-explained clipping operation is outputted to a storage apparatus 54 by way of an image output function.

The module producing unit 141 of FIG. 4 produces the image input process module 51 from the image input function provided by the image process unit 13 of FIG. 1, the clip process module 52 from the clip process function, and the image output process module 53 from the image output process function on the memory secured by the memory securing unit 142, and then, this module producing unit 141 connects the respective process modules 51, 52, 53 to each other in order to constitute a pipeline structure. At this time, while a byte number of a necessary buffer, and information related to a clip region are given to the clip process module 52, this clip process module 52 calculates an output buffer based upon the above-described output buffer so as to produce both the input buffer and the output buffer, and then holds such an information required for executing a clip process operation.

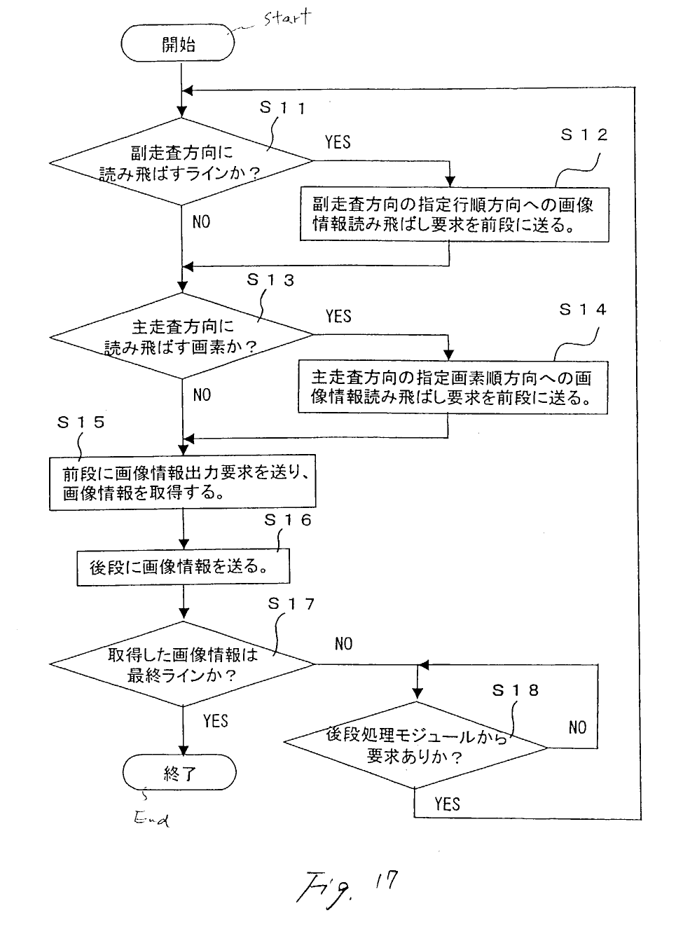

FIG. 17 is a flowchart for describing general process flow operations of the clip process module 52. With reference to this flow chart, the general process operation of the clip process module 52 will now be explained.

When an image information output request is issued from the image output process module 53 corresponding to a post-staged process module, the clip process module 52 judges as to whether or not such an image information corresponds to a read-skipping line along a sub-scanning direction, while this image information should be obtained when the image information output request is sent to a pre-staged process module (step S11). In the case that this image information corresponds to the read-skipping line, the clip process module 52 sends an image information read-skipping request for a line number designated along the sub-scanning direction in a forward direction to the pre-staged process module (step S12).

In the case that the execution of the process operation of the step S12 is accomplished, or the clip process module 52 judges that the image information is not the read-skipping line in the step S11, the clip process module 52 judges as to whether or not a head pixel of such an image information corresponds to a read-skipping pixel along the main scanning direction, while this image information should be obtained when the image information output request is sent to the pre-staged process module (step S13). In the case that this image information corresponds to the read-skipping pixel, the clip process module 52 sends an image information read-skipping request for a pixel number designated along the main scanning direction in a forward direction to the pre-staged process module (step S14).

In the case that the execution of the process operation of the step S14 is accomplished, or the clip process module 52 judges that the image information is not the read-skipping pixel, this clip process module 52 sends an image information output request to the pre-staged process module so as to acquire the image information (step S15). In this case, when the byte number of the input buffer corresponds to such a byte number capable of holding pixels which constitute a width of a clip region, the clip process module 52 merely copies a byte number of pixels for the width for clipping the acquired image information in this order defined from the head pixel into the input buffer, but need not execute other process operations for the image information.

Subsequently, the clip process module 52 copies the image information of the input buffer to the output buffer, and sends the image information copied in the output buffer to a post-staged process module (step S16). It should also be noted that as previously explained, the image information of the input buffer may be directly sent to the post-staged process module. Next, the clip process module 52 judges as to whether or not the image information which is acquired from the pre-staged process module in the process operation of the step S15 corresponds to a final line of the image (step S17). In the case that this acquired image information corresponds to the final line, a series of the process operations is accomplished. To the contrary, in the case that this acquired image information does not correspond to the final line, the clip process module 52 waits for a certain request issued from the post-staged process module (step S18). When the next image output request is issued, the clip process operation is returned to the previous step S11, and then, the clip process module 52 executes a similar process operation as to the next line.

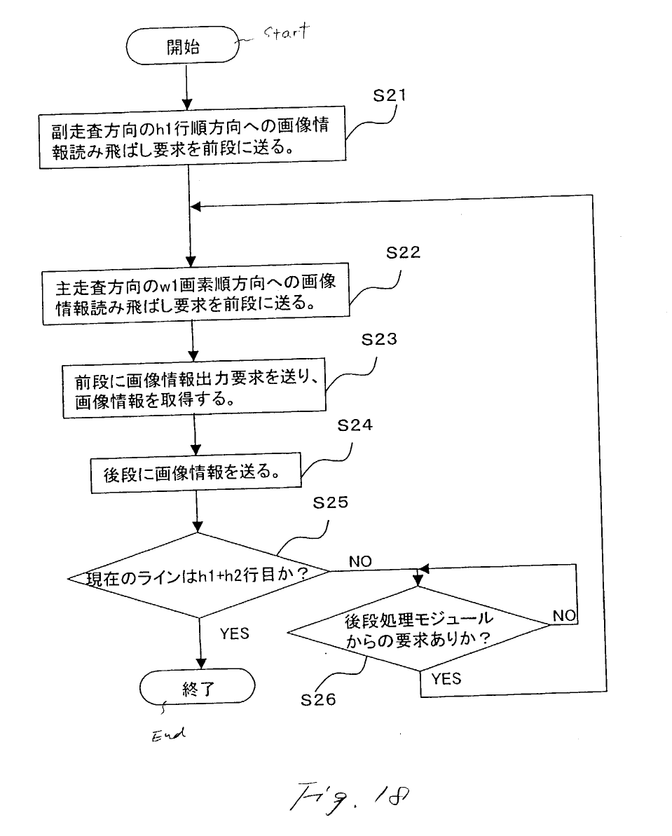

FIG. 18 is a flow chart for describing process flow operations executed in the case that the clip process module 52 processes the image 60.

An image information process starting position is set to a head pixel of a first head line. Since a clip region is not present from the head line up to an “h1-th” line, such an image information up to this “h1-th” line is not required. Thus, the clip process module 52 sends an image information read-skipping request of the h1 lines along the sub-scanning direction in the forward direction to the image input process module 51 corresponding to the pre-staged process module, and sets the image information process starting position to a head pixel of an (h1+1)-th line (step S21).

The image information process starting position is located on such a line where the clip region is present, but is set to a head pixel whose image information is not utilized. As a result, since such an image information defined from the head pixel up to a “w1-th” pixel is not required, the clip process module 52 sends an image information read-skipping request for the “w1” pixels along the main scanning direction in the forward direction to the pre-staged process mode, and sets the image information process starting position to a “(w1+1)-th” pixel (step S22).

Next, the clip process module 52 sends an image information output request to the pre-staged process module so as to acquire image information (step S23). In this case, the image information which is acquired by the clip process module 52 corresponds to a byte number of pixel numbers (w2+w3). In such a case that a byte number of an input buffer is equal to the byte number of the pixel number (w2), the clip process module 52 copies the acquired image information for the byte number of the pixel number (w2) to the input buffer in this order of the head pixel.

Next, the clip process module 52 copies the image information of the input buffer to the output buffer, and sends the image information copied in the output buffer to the post-staged process module (step S24). It should also be noted that as explained above, the image information of the input buffer may be directly sent to the post-staged process module.

Next, the clip process module 52 judges as to whether or not the present line corresponds to an (h1+h2)-th line which implies a final line of the clip region (step S25). In the case that the present line corresponds to this (h1+h2)-th line, since this (h1+h2)-th line and the succeeding lines are not required, the clip process module 52 accomplishes a series of the above-described process operations. To the contrary, when the present line does not correspond to this (h1+h2)-th line, the clip process module 52 waits for an image information output request issued from the post-staged process module (step S26). Upon receipt of this image output information request, the process operation by the clip process module 52 is returned to the previous step S22 so as to repeatedly execute a series of the above-explained process operations with respect to the next line.

As previously explained, in the pipeline process structure constructed by connecting a plurality of process modules involving the clip process module 52, since the clip process module 52 is equipped with the image information read-skipping function, the useless reading process operation of the image information to the clip process module 52 can be suppressed. As a consequence, the pipeline process operation can be carried out at high speeds, and furthermore, since the reading operation of the image information is skipped to the necessary image information position, the reading operation of the unnecessary image information can be avoided and also the useless buffering operation can be avoided, so that the memory resource consumption amount can be suppressed.

### SECOND EXAMPLE

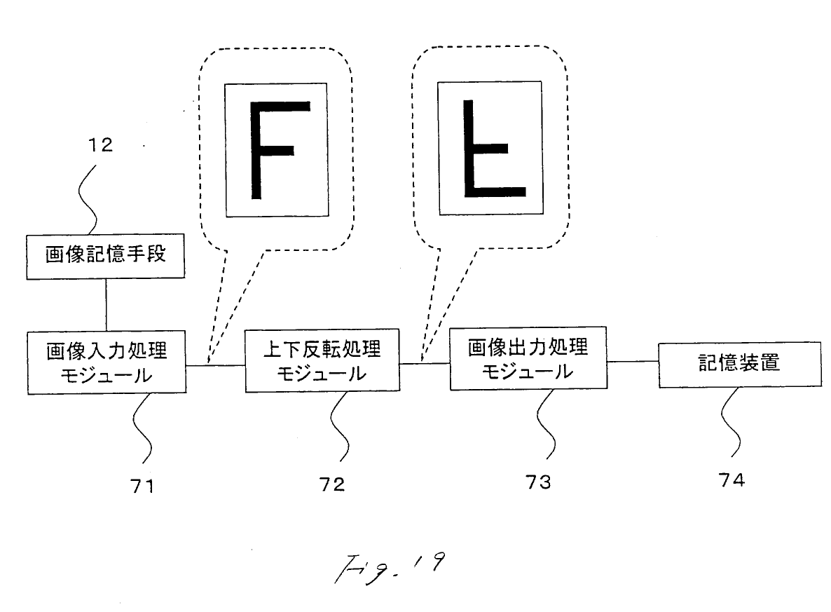

As indicated in a schematic block diagram of FIG. 19, this second concrete example corresponds to such an example as to operations of an up/down inverting process module 72 which processes the image stored in the image storage unit 12 of FIG. 1 in such a case that a pipeline structure is constituted by connecting an image input process module 71, this up/down inverting process module 72, and an image output process module 73 to each other.

First, the memory securing unit 142 of FIG. 4 secures a memory which is required in order to produce process modules based upon an image process instruction stored in the process storage unit 11 of FIG. 1. In this second concrete example, the image process instruction implies such an process operation that the image is read out from the image storage unit 12 by way of the image input function, the read image is vertically inverted by way of an up/down inverting process function, and then, the up/down-inverted image information is outputted to the storage apparatus 74 by way of the image output function.

The module producing unit 141 of FIG. 4 produces the image input process module 71 from the image input function provided by the image process unit 13 of FIG. 1, the up/down process module 72 from the up/down process function, and the image output process module 73 from the image output process function on the memory secured by the memory securing unit 142, and then, this module producing unit 141 connects the respective process modules 71, 72, and 73 to each other in order to constitute a pipeline structure. At this time, while a byte number of a necessary buffer, a byte number of an output buffer, and the like are given to the up/down inverting process module 72, this up/down inverting process module 72 produces an input buffer and an output buffer, and then stores the information which is required for the up/down inverting process operation.

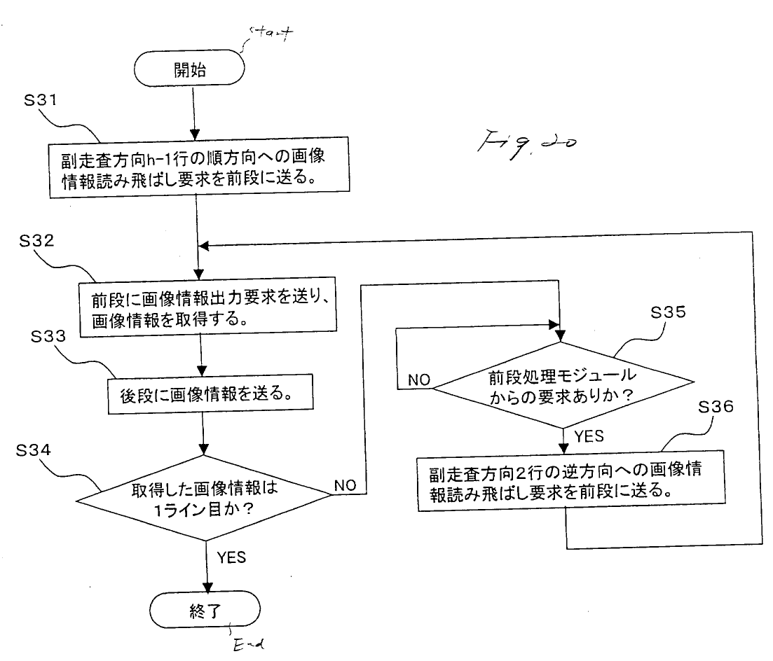

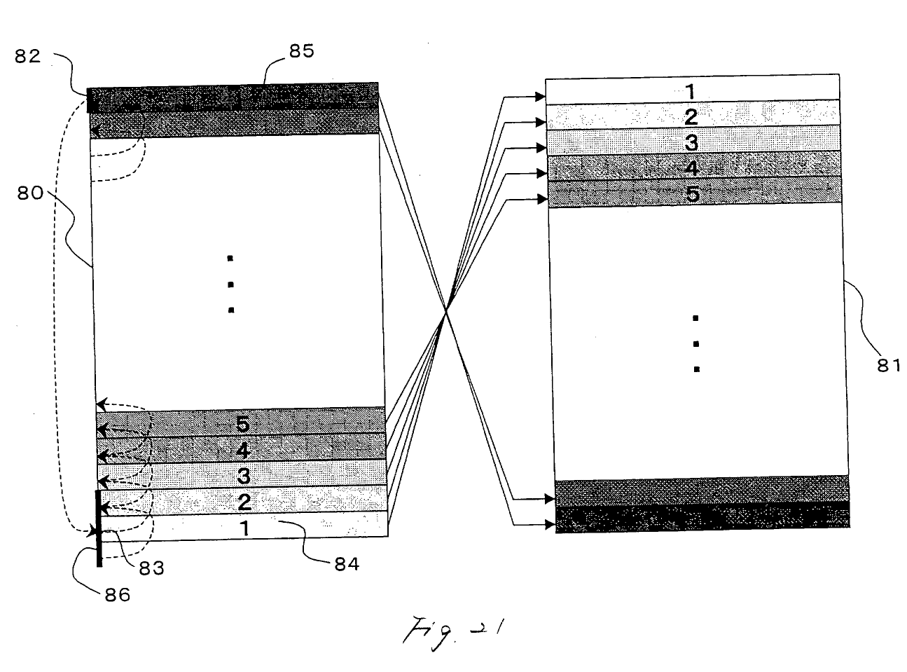

FIG. 20 is a flow chart for describing process flow operations of the up/down inverting process module 72 executed in the case that the up/down inverting process operation as to such an image having a height of “h” and a width of “w” is carried out by this up/down inverting process module 72. Further, FIG. 21 is an explanatory diagram for explaining the up/down inverting process operation. In this drawing, an image 80 indicates such an image obtained before the up/down inverting process operation is carried out, whereas another image 81 represents such an image obtained after the up/down inverting process operation is executed.

First, the image information process starting position is set to a position 82. When the up/down inverting process module 72 receives an image output request from the image output process module 73 corresponding to a post-staged process module, this up/down inverting process module 72 sends an image information read-skipping request for (h-1) lines along the sub-scanning direction in the forward direction to the image input process module 71 corresponding to a pre-staged process module, and sets the image information process starting position to a head pixel (namely, position 83) in a final line (step S31).

Next, the up/down inverting process module 72 sends an image information output request to the pre-staged process module, and acquires image information for 1 line (step S32). Then, the image information process starting position is moved to a head pixel of a line subsequent to the acquired line. For example, when a description is made of such a case that image information 84 is acquired, the image information process starting position is the position 83 before the image information 84 is acquired, whereas the image information process starting position after the image information 84 is acquired is moved to another position 86.

Subsequently, the up/down inverting process module 72 sends the acquired image information to the post-staged process module (step S33). Next, the up/down inverting process module 72 judges as to whether or not the acquired image information corresponds to image information 85 of a first line in the image 80 (step S34). When the acquired image information corresponds to the image information 85, a series of the process operations is accomplished. To the contrary, when the acquired image information does not correspond to the image information 85, the up/down inverting process module 72 waits for a next image information output request issued from the post-staged process module (step S35). Upon receipt of this image information output request, the up/down inverting process module 72 sends an image information read-skipping request for 2 lines along the sub-scanning direction in the backward direction to the pre-staged process module, sets the image information process starting position to a head pixel of such a line located before the first line by 2 lines (step S36), and thereafter, the up/down inverting process operation thereof is returned to the previous step S32 so as to repeatedly execute a series of the above-explained process operations.

As previously explained, in the pipeline process structure constructed by connecting a plurality of process modules involving the up/down inverting process module 72, since the up/down inverting process module 72 is equipped with the image information read-skipping function, only such an input buffer for 1 line is required by executing the read-skipping operation along the sub-scanning direction in the backward direction, although the image buffer is required in the conventional up/down inverting process operation. As a result, the up/down inverting process operation can be carried out without consuming the useless memory.

As previously explained, in accordance with the present invention, since the image information read-skipping function capable of skipping the reading operation of partial unnecessary information of the image is provided in the process module, the useless reading process operation to the process module can be suppressed. As a result, the image processing operation can be carried out in higher speeds. Moreover, since the reading operation of the image information is skipped to the necessary image information position and thus the useless buffering operation can be avoided, the memory consumption amount can be suppressed.

Furthermore, since the control function capable of judging as to whether or not the reading operation of the image information is skipped is given to this process module in addition to the above-described image information read-skipping function, for example, in such a compressed information case that if the reading operation of the input image information is skipped then the image information inputted to the process module is dropped, the control operation can be carried out in such a manner that the image process operation is carried out without skipping the image information. As a consequence, the connection to the process module can be executed without paying any attention to such a condition as to whether the input information to this process module is the compressed information, or the non-compressed information.

[FIG. 1]

10: image processing apparatus

11: process storage unit

12: image storage unit

13: image processing unit

14: process execution control unit

20: host application program

[FIG. 2]

13: image processing unit

131-1: processing function 1

131-i: processing function i

131-N: processing function N

132: image information read-skipping unit

[FIG. 3]

13a: image processing unit

131-1: processing function 1

131-N: processing function N

132: image information read-skipping unit

[FIG. 4]

14: process execution control unit

141: module producing unit

142: memory securing unit

[FIG. 5]

21: process module

211: input buffer

212: control unit

213: output buffer

22: pre-staged process module

221: input buffer

222: control unit

223: output buffer

23: post-staged process module

231: input buffer

232: control unit

233: output buffer

[FIG. 6]

21: process module

211: input buffer

212: control unit

213: output buffer

22: pre-staged process module

221: input buffer

222: control unit

223: output buff

[FIG. 7]

21: process module

211: input buffer

212: control unit

213: output buffer

22: pre-staged process module

221: input buffer

222: control unit

223: output buffer

[FIG. 8]

21: process module

211: input buffer

212: control unit

213: output buffer;

22: pre-staged process module

221: input buffer

222: control unit

223: output buffer

[FIG. 9]

21: process module

211: input buffer

212: control unit

213: output buffer

22: pre-staged process module

221: input buffer

222: control unit

223: output buffer

[FIG. 10]

13b: image processing unit

131-1: processing function 1

131-i: processing function i

131-N: processing function N

132: image information read-skipping unit

133: image information read-skipping control unit

[FIG. 11]

13c: image processing unit

131-1: processing function 1

131-i: processing function i

131-N: processing function N

132: image information read-skipping unit

133: image information read-skipping control unit

[FIG. 12]

13d: image processing unit

131-1: processing function 1

131-i: processing function i

131-N: processing function N

132: image information read-skipping unit

133: image information read-skipping control unit

[FIG. 13]

21: process module

211: input buffer

212: control unit

213: output buffer

22: pre-staged process module

221: input buffer

222: control unit

223: output buffer

23: post-staged process module

231: input buffer

232: control unit

233: output buffer

[FIG. 14]

21a: process module

211: input buffer

212: control unit

[FIG. 15]

12: image storage unit

51: image input process module

52: clip process module

53: image output process module

54: storage apparatus

[FIG. 16]

61: clip region

[FIG. 17]

S11: reading of line is skipped along sub-scanning direction?

S12: send image information read-skipping request for designated line along sub-scanning direction in forward direction to pre-staged process module

S13: reading of pixel is skipped along main scanning direction?

S14: send image information read-skipping request for designated pixel along main scanning direction in forward direction to pre-staged process module

S15: send image information output request to pre-staged process module so as to acquire image information

S16: send image information to post-staged process module

S17: acquired image information corresponds to final line?

S18: request is issued from post-staged process module?

[FIG. 18]

S21: send image information read-skipping request for “h1” line along sub-scanning direction in forward direction to pre-staged process module

S22: send image information read-skipping request for “w1” pixel along main scanning direction in forward direction to pre-staged process module

S23: send image information output request to pre-staged process module so as to acquire image information

S24: send image information to post-staged process module

S25: present line corresponds to (h1+h2)-th line?

S26: request is issued from post-staged process module?

[FIG. 19]

12: image storage unit

71: image input process module

72: up/down inverting process module

73: image output process module

74: storage apparatus

[FIG. 20]

S31: send image information read-skipping request for (h−1)-th line along sub-scanning direction in forward direction to pre-staged process module

S32: send image information output request to pre-staged process module so as to acquire image information

S33: send image information to post-staged process module

S34: acquired image information corresponds to first line?

S35: request is issued from pre-staged process module?

S36: send image information read-skipping request for 2 lines along sub-scanning direction in backward direction to pre-staged process module

What is claimed is:

1. An image processing apparatus comprising:
a plurality of processing unit which are connected to each other in a pipeline mode so as to execute predetermined process operations respectively, wherein
at least one of said plural processing unit includes image information read-skipping unit for skipping a reading operation of a portion of image information to be processed, while said processing unit executes a predetermined process operations.

2. The image processing apparatus as in claim 1, wherein
said image information read-skipping unit includes: at least one of
a read-skipping function executed along a forward direction with respect to a sub-scanning direction;
a read-skipping function executed along a backward direction with respect to the sub-scanning direction;
a read-skipping function executed along the forward direction with respect to a main scanning direction; and
a read-skipping function executed along the backward direction with respect to the main scanning direction.

3. The image processing apparatus as in claim 1, wherein
said image information read-skipping unit includes: at least two of
a read-skipping function executed along a forward direction with respect to a sub-scanning direction;
a read-skipping function executed along a backward direction with respect to the sub-scanning direction;
a read-skipping function executed along the forward direction with respect to a main scanning direction; and
a read-skipping function executed along the backward direction with respect to the main scanning direction, and selects any one of the plural functions to execute the selected function.

4. The image processing apparatus as in claim 1, wherein
at least one of said plural processing unit further comprises:
image information read-skipping control unit for controlling said image information read-skipping unit based upon a sort of an image processing instruction.

5. An image processing method wherein:
in a pipeline process structure constituted by connecting a plurality of processing modules for executing predetermined process operations in a pipeline mode, at least one of said plural processing modules includes:
an image information read-skipping function for skipping a reading operation of a portion of image information to be processed, while said processing module executes a predetermined process operation.

6. The image processing method as in claim 5, wherein
at least one of said plural processing modules includes:
an image information read-skipping control function capable of controlling the image information read-skipping function based upon a sort of an image processing instruction in addition to the image information read-skipping function.
